(19) United States
(12) Patent Application Publication
(10) Pub. No.: US 2026/0079334 A1
(43) Pub. Date: Mar. 19, 2026

(54) CONTROLLING LIGHT ENGINES FOR ILLUMINATION

(71) Applicant: ALCON INC., Fribourg (CH)

(72) Inventors: Jing Xu, Irvine, CA (US); Chris Medford, Huntington Beach, CA (US); John Park, Irvine, CA (US)

(21) Appl. No.: 19/317,274

(22) Filed: Sep. 3, 2025

Related U.S. Application Data
(60) Provisional application No. 63/695,984, filed on Sep. 18, 2024.

(51) Int. Cl. G02B 21/00; H05B 47/165

(52) U.S. Cl. CPC G02B 21/0032; H05B 47/165

(57) ABSTRACT

In certain embodiments, an illumination system for a microscope includes an illumination source and a computer. The illumination source comprises light engines. The computer receives an illumination request comprising a color request and an intensity request. The color request includes color selections, where each color selection requests a color output for at least a subset of the light engines. The intensity request includes intensity selections, where each intensity selection requests an intensity output for at least a subset of the light engines. The computer determines intensity inputs according to the intensity request, where each intensity input provides an illumination instruction to a light engine. The computer determines color inputs according to the color request, where each color input provides a color instruction to a light engine. The computer generates light engine inputs from the intensity inputs and the color inputs and sends the light engine inputs to the light engines.

### FIELD

Embodiments of the present disclosure relate to controlling light engines for illumination.

### BACKGROUND

Viewing devices allow a user to view a target. For example, a microscope typically magnifies the image of a small target to allow the user to view the target. Viewing devices may include an illumination system that illuminates the target. In some cases, the illumination of the target may be the most important controllable variable for achieving high-quality viewing. Certain illumination systems include light engines that provide the light that yields the illumination. The light engines may be controlled to provide a specific type of illumination.

### SUMMARY

In certain embodiments, an illumination system for a microscope includes an illumination source and a computer. The illumination source comprises light engines. Each light engine emits an illumination output having a color and an intensity. Each light engine is associated with a maximum intensity. The computer receives an illumination request comprising a color request and an intensity request. The color request includes one or more color selection(s), where each color selection requests a color output for at least a subset of the light engines. The intensity request includes one or more intensity selection(s), where each intensity selection requests an intensity output for at least a subset of the light engines. The computer determines intensity inputs according to the intensity request, where each intensity input provides an illumination instruction to a light engine. The computer determines color inputs according to the color request, where each color input provides a color instruction to a light engine. The computer generates light engine inputs from the intensity inputs and the color inputs and sends the light engine inputs to the light engines.

Embodiments may include none, one, two, more, any combination of, or all of the following.

The computer calculates intensity normalizing factors according to the maximum intensity values of the light engines, where each intensity normalizing factor is associated with a light engine, and determines the intensity inputs according to the intensity normalizing factors.

An intensity selection comprises an intensity distribution selection that requests a distribution of intensity output values for two or more light engines. The computer calculates two or more intensity scaling factors according to the distribution of the intensity output values, where each intensity scaling factor is associated with a light engine of the two or more light engines. The computer determines two or more intensity inputs according to the two or more intensity scaling factors, where each intensity input is associated with the two or more light engines. Each light engine of the two or more light engines may be associated with a scaling portion value indicating a portion of intensity output to be provided by the light engine. The computer may calculate the two or more intensity scaling factors according to the two or more scaling portion values. The intensity distribution selection may comprise a combined intensity selection requesting a combined intensity output for the two or more light engines. The intensity distribution selection may comprise an overall intensity selection requesting an overall intensity output for the engines. The intensity distribution selection may comprise a relative intensity selection requesting two or more relative intensity values for the two or more light engines. The computer may calculate the two or more intensity scaling factors according to the two or more relative intensity values.

The one or more color selection(s) comprise multiple color selections, where each color selection requests a color output for a distinct subset of the light engines. The computer determines the color inputs according to the color selections.

The computer further checks whether the color request is in an accepted color format. If the color request is not in an accepted color format, the computer converts the color request to an accepted color format.

The illumination system includes a beam director that can receive the illumination output from each light engine and direct the illumination output from the light engine along an optical pathway corresponding to the light engine. The beam director may direct the illumination output by directing one or more coaxial illumination output(s) to one or more coaxial optical pathway(s) that are parallel to an optical axis of the microscope. The beam director may direct the illumination output by directing one or more oblique illumination output(s) along one or more oblique optical pathway(s) that are oblique to an optical axis of the microscope.

The illumination system includes a display device that presents a graphical user interface with one or more intensity selector(s), where each intensity receives an intensity selection. The computer receives the intensity request comprising the intensity selection(s) from the intensity selector(s).

The illumination system includes a display device that presents a graphical user interface with one or more color selector(s), where each color selector receives a color selection. The computer receives the color request comprising the color selection(s) from the color selector(s).

In certain embodiments, an illumination system for a microscope includes an illumination source, a display device, and a computer. The illumination source comprises light engines, where each light engine emits an illumination output having a color and an intensity. The display device presents a graphical user interface that generates an illumination request. The graphical user interface has a color graphical component and an intensity graphical component. The color graphical component includes one or more color selector(s), where each color selector receives a color selection from multiple color options. The intensity graphical component includes one or more intensity selector(s), where each intensity selector receives an intensity selection from multiple intensity options. The illumination request comprises the color selection(s) and the intensity selection(s). The computer receives the illumination request from the display device, generates light engine inputs from the color selection(s) and the intensity selection(s), and sends the light engine inputs to the light engines.

Embodiments may include none, one, two, more, any combination of, or all of the following.

The display device presents a color selector as one or more field(s) that can receive input representing the color selection.

The display device presents a color selector as a graphic representing a color coordinate map and detects selection of a coordinate of the color coordinate map as the color selection.

The display device presents a color selector as a graphic representing a color curve and detects selection of a point of the color curve as the color selection.

The display device presents a color selector as a color temperature selector that can receive a color temperature selection from color temperature options.

The display device presents a color selector as a multiple color selector that can receive multiple color selections. Each color selection requests a color output for the illumination output emitted by a distinct subset of the light engines.

The display device presents an intensity selector as an illumination output intensity selector that can receive an illumination output intensity selection for the illumination output emitted by one or more light engine(s).

The display device presents an intensity selector as an intensity distribution selector that can receive a distribution of one or more intensity output value(s) for the illumination output emitted by two or more light engines.

The display device presents an intensity selector as a combined intensity selector that can receive a combined intensity selection for the illumination output emitted by two or more light engines.

The display device presents an intensity selector as an overall intensity selector that can receive an overall intensity selection for the illumination output emitted by the light engines.

The display device presents an intensity selector as a relative intensity selection that can receive two or more relative intensity values for the illumination output emitted by two or more light engines.

### BRIEF DESCRIPTION OF THE DRAWINGS

FIG. 1 illustrates an example microscope that can be used to view a target, according to at least one embodiment described in the present disclosure;

FIGS. 2A and 2B illustrate examples of illumination systems with beam directors (e.g., beam splitters and/or combiners) and illumination sources of a microscope, according to at least one embodiment described in the present disclosure;

FIG. 3 illustrates an example computer system, according to at least one embodiment described in the present disclosure;

FIG. 4 illustrates an example of an illumination system, according to at least one embodiment described in the present disclosure;

FIG. 5 illustrates an example of computer applications of a computer of an illumination system, according to at least one embodiment described in the present disclosure;

FIG. 6 illustrates an example graphical user interface shown on a display device, according to at least one embodiment described in the present disclosure;

FIGS. 7A through 7F illustrate example graphical user interfaces, according to at least one embodiment described in the present disclosure;

FIG. 8 illustrates an example of a method of generating light engine inputs, according to at least one embodiment described in the present disclosure;

FIG. 9 illustrates another example of a method of generating light engine inputs, according to at least one embodiment described in the present disclosure;

FIG. 10 illustrates another example of a method of generating light engine inputs, according to at least one embodiment described in the present disclosure; and

FIG. 11 illustrates another example of a method of generating light engine inputs, according to at least one embodiment described in the present disclosure.

### DESCRIPTION OF EXAMPLE EMBODIMENTS

Referring now to the description and drawings, one or more example embodiments of the disclosed apparatuses, systems, and methods are shown in detail. The description and drawings are not intended to be exhaustive or otherwise limit the claims to the specific embodiments shown in the drawings and disclosed in the description. Although the drawings represent possible embodiments, the drawings are not necessarily to scale and certain features may be simplified, exaggerated, removed, or partially sectioned to better illustrate the embodiments.

The present disclosure relates to illumination systems, such as an illumination system for a microscope, e.g., an ophthalmic microscope. In certain embodiments, the illumination system has multiple light engines, e.g., light emitting diode (LED) light engines, which provide light having a color and an intensity. A computer that controls the illumination system receives a request that includes, e.g., a requested color and/or a requested intensity for the illumination. The computer generates illumination instructions that instruct each light engine to produce light such that the illumination from the light engines has the requested color and/or the requested intensity, respectively.

Certain embodiments of the present disclosure may provide improvements over known illumination systems. For example, certain embodiments may generate illumination instructions for coaxial light engines that provide coaxial illumination for a microscope and illumination instructions for an oblique light engine that provides oblique illumination for the microscope, or combinations thereof. As another example, the embodiments may provide a user interface that allows a user to select the color and/or the intensity for the coaxial illumination and the color and/or the intensity for the oblique illumination. As another example, the embodiments may provide a user interface that allows a user to select a total illumination (e.g., an overall illumination) and have the total illumination automatically divided between the oblique illumination and coaxial illumination.

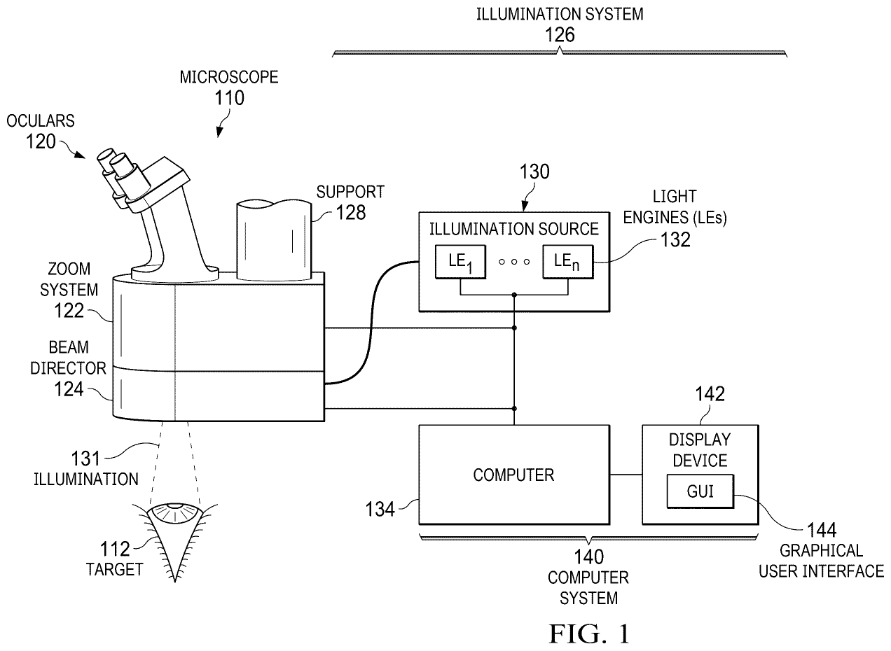

FIG. 1 illustrates an example microscope 110 that can be used to view a target 112, e.g., an eye, according to at least one embodiment described in the present disclosure. In the illustrated example, the microscope 110 includes oculars 120, a zoom system 122, a beam director 124, an illumination system 126, and a support 128, which may be coupled as shown. The illumination system 126 provides illumination 131 to illuminate the target 112. The illumination system 126 includes an illumination source 130 and a computer system 140, which may be coupled as shown. The illumination source has light engines (LE₁, . . . , LEₙ) 132, and the computer system 140 includes a computer 134, a display device 142, and a graphical user interface (GUI) 144, which may be coupled as shown.

In an example of operation, the computer 134 receives an illumination request for the illumination source 130 that has light engines 132. Each light engine 132 may have different colors (e.g. red, green, and blue) of light sources that can be used to compose light according to an illumination request. In the example, the illumination request includes a color request and an intensity request. The color request has one or more color selections, where each color selection requests a color output for at least a subset of the light engines 132 or directions of illumination. The intensity request has one or more intensity selections, where each intensity selection requests an intensity output for at least a subset of the light engines 132. The computer 134 determines intensity inputs (e.g., using a light control process) according to the intensity request (where each intensity input provides an illumination instruction to a light engine 132) and determines color inputs according to the color request (where each color input provides a color instruction to a light engine 132). The computer 134 then generates light engine inputs from the intensity inputs and the color inputs and sends the light engine inputs to light engines 132, which emit illumination outputs with the colors and the intensities as instructed by the light engine inputs.

Turning to the components of the example, the target 112 may be any suitable object that may be illuminated by the illumination system 126, e.g., a sample, a specimen, a biological tissue, and/or a body part. In certain cases, the target 112 may be, e.g., an eye, viewed by the microscope 110.

The microscope 110 may be any suitable instrument used to magnify an object, e.g., an optical microscope and/or a digital microscope. Examples of the microscope 110 include diagnostic microscopes, surgical microscopes, and/or ophthalmic microscopes. The oculars 120 of the microscope 110 magnify the image of the objective lens to allow the user to view the target 112. The zoom system 122 changes the magnification of the target 112. The beam director 124 directs (e.g., guides, splits, and/or combines) illumination beams from the illumination source 130 towards the target 112. In certain embodiments, the beam director 124 receives light from a light engine LEᵢ and directs the light along an optical pathway corresponding to the light engine LEᵢ. For example, light from a light engine that provides coaxial light is directed along a coaxial pathway that is substantially aligned with (e.g., parallel to) the optical axis. As another example, light from a light engine that provides oblique light is directed along an oblique pathway that is at an oblique angle relative to the optical axis. Examples of the beam director 124 and of coaxial lighting and oblique lighting are described in more detail below. The support 128 couples the microscope 110 to a structure, e.g., a microscope stand, a medical system, or other suitable device designed to be coupled to the microscope 110.

The illumination system 126 illuminates an object, such as the target 112 of the microscope 110. In the example, the illumination system 126 includes the illumination source 130, which may provide light of any suitable wavelength, e.g., any suitable range of visible light, near-visible light, infrared light, and/or ultraviolet light. The illumination source 130 has light engines 132 that provide the light. A light engine 132 includes any suitable combination of one or more light sources and may include a light source driver and other optical, thermal, mechanical, and/or electrical components. Examples of light sources include lamps (e.g., incandescent lamps, fluorescent lamps, and/or high-intensity discharge (HID) lamps) and/or solid-state lighting (SSL) (e.g., semiconductor light-emitting diodes (LEDs), organic light-emitting diodes (OLED), and/or polymer light-emitting diodes (PLED)). The light sources of light engines 132 may be similar to each other or may be different from each other. In certain embodiments, the light engines 132 include LED light engines.

A light engine 132 emits light (as illumination output) with any suitable color and any suitable intensity. In certain embodiments, a light engine 132 includes LEDs that emit red, green, and/or blue light. The light engine 132 can control the relative emissions of the red, green, and/or blue light in response to instructions to control the color of the overall light output. In certain embodiments, a light engine 132 controls the intensity of the overall light output in response to instructions of a light engine input. In the embodiments, the intensity may be limited by the maximum intensity value of the light engine 132.

In the example, the illumination system 126 includes the computer system 140, which includes the computer 134. The computer 134 sends instructions to control the components of the illumination system 126 and/or the microscope 110. In certain embodiments, the computer 134 receives an illumination request for the color and/or the intensity of the illumination light and generates light engine input that instructs the individual light engines 132 to generate light that yields illumination that satisfies the requested color and/or intensity, respectively.

For example, the computer 134 receives an illumination request that has a color request and an intensity request. The color request has one or more color selections, where each color selection requests a color output for at least a subset of the light engines 132. For example, the color request may request particular colors for coaxial light and for oblique light. The intensity request has one or more intensity selections, where each intensity selection requests an intensity output for at least a subset of the light engines 132. For example, the color request may request particular intensity values for the coaxial light and for the oblique light. The computer 134 determines intensity inputs according to the intensity request (where each intensity input provides an illumination instruction to a light engine 132) and determines color inputs according to the color request (where each color input provides a color instruction to a light engine 132). The computer 134 generates light engine inputs from the intensity inputs and the color inputs and sends the light engine inputs to light engines 132, which emit illumination outputs with colors and the intensities as instructed by the light engine inputs.

The computer system 140 includes the display device 142 and the graphical user interface (GUI) 144. The display device 142 presents the GUI 144. A user may use the GUI 144 to send information to and receive information from the computer system 140. In certain embodiments, the GUI 144 may allow the user to provide color selections and/or intensity selections for an illumination request. Examples of the computer system 140, the computer 134, the display device 142, and the graphical user interface (GUI) 144 are described in more detail below.

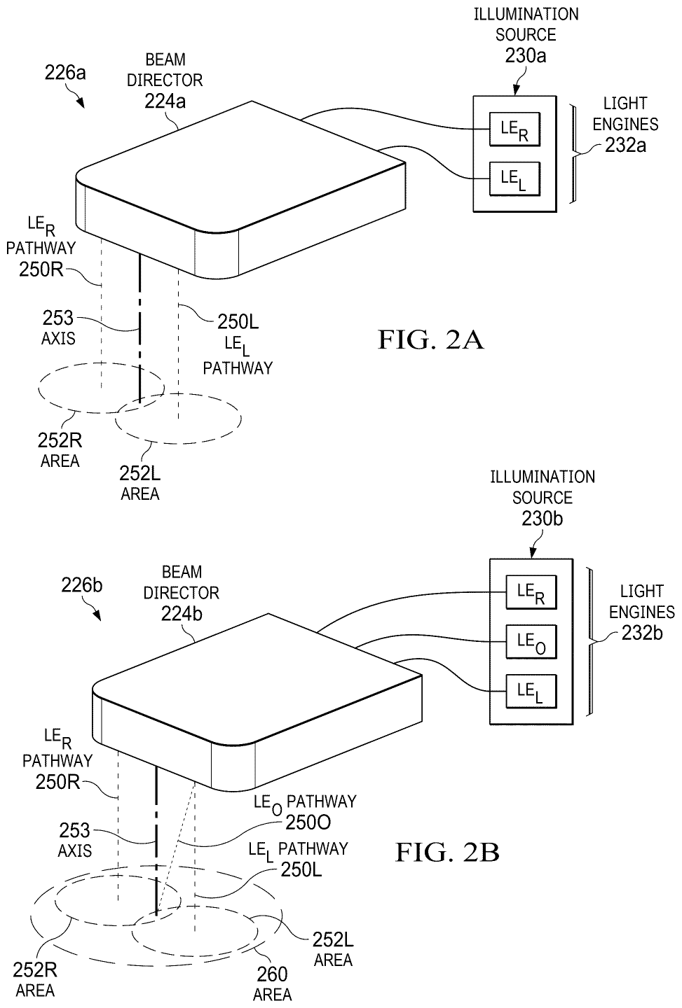

FIGS. 2A and 2B illustrate examples of illumination systems 226 (226a and/or 226b) with beam directors 224 (224a and/or 224b, respectively) and illumination sources 230 (230a and/or 230b, respectively) of a microscope, according to at least one embodiment described in the present disclosure. In the examples, a beam director 224 (224a or 224b) is optically coupled to an illumination source 230 (230a or 230b, respectively) that includes light engines 232 (232a or 232b, respectively) LE₁, . . . , LEₙ. The beam director 224 (224a or 224b) receives illumination output from each light engine LEᵢ 232 (232a or 232b, respectively) and directs (e.g., guides, splits, and/or combines) the illumination output along an optical pathway corresponding to the light engine LEᵢ 232 (232a or 232b, respectively). Examples of beam directors include beam splitters (e.g., a prism or a partial reflection mirror) and beam combiners.

FIG. 2A shows an example beam director 224a coupled to an illumination source 230a that includes light engines 232a LE_{R} and LE_{L}. In the example, the light engines 232a LE_{R} and LE_{L} provide right and left stereoscopic coaxial illumination outputs, respectively. Generally, the beam director 224a may direct one or more coaxial illumination outputs along one or more coaxial optical pathways that are substantially parallel to the optical axis 253 of the microscope. In the example, the beam director 224a directs coaxial illumination outputs from light engines 232a LE_{R} and LE_{L} along coaxial optical pathways 250R and 250L, respectively, to yield coaxially illuminated areas 252R and 252L, respectively.

FIG. 2B shows a beam director 224b coupled to an illumination source 230b that includes light engines 232b LE_{R}, LE_{O}, and LE_{L}. Light engines 232b LE_{R} and LE_{L} are substantially similar to light engines 232a LE_{R} and LE_{L}, respectively. The light engine 232b LE_{O} provides an oblique illumination output that is oblique (by, e.g., 1 to 20 degrees, such as 1 to 5, 5 to 10, 10 to 15, and/or 15 to 20 degrees) to the optical axis 253 of the microscope. In some cases, the oblique illumination may improve red reflex viewing. Generally, the beam director 224 may direct an oblique illumination output along an oblique optical pathway, in addition to directing one or more coaxial illumination outputs along one or more coaxial optical pathways. In the example, the beam director 224b directs an oblique illumination output from light engine LE_{O} along the oblique optical pathway 250O to yield an obliquely illuminated area 260, as well as direct coaxial illumination outputs from light engines 232a LE_{R} and LE_{L} along coaxial optical pathways 250R and 250L, respectively, to yield coaxially illuminated areas 252R and 252L, respectively.

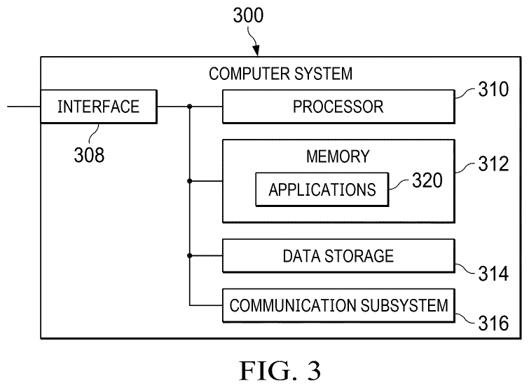

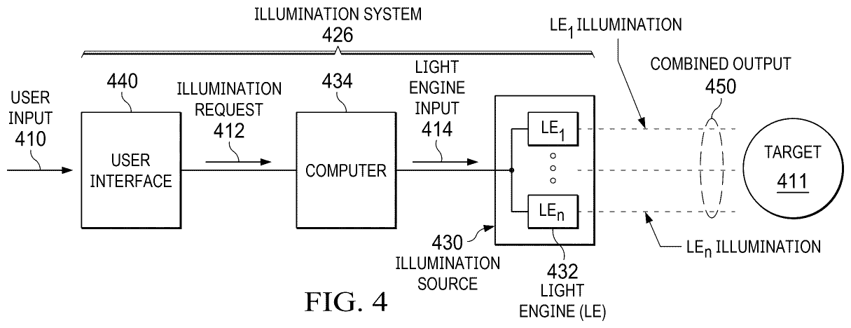

FIG. 3 illustrates an example computer system 300, according to at least one embodiment described in the present disclosure. The computer system 300 may include an interface 308, a processor 310, a memory 312, a data storage 314, and/or a communication subsystem 316, any or all of which may be communicatively coupled. Any or all of the computer system 300 may be implemented as computer hardware and/or software. Any or all of the system 100 of FIG. 1 may be implemented as a computer system consistent with the computer system 300.

In the example, the interface 308 may receive input to the computer system 300 and/or send output from the computer system 300, and may be used to exchange information between, e.g., software, hardware, one or more peripheral devices, one or more users, and/or any suitable combinations of any of the preceding. A user interface is a type of interface that a user can utilize to communicate with (e.g., send input to and/or receive output from) the computer system 300. Examples of user interfaces include display devices (e.g., a computer screen and/or a touchscreen), Graphical User Interfaces (GUIs), foot pedals, touchscreens, keyboards, computer mouses (or mice), gesture sensors, microphones, and speakers.

Generally, the processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor, the processor 310 may include any number of processors distributed across any number of network or physical locations that are configured to perform individually or collectively any number of operations described in the present disclosure.

The processor 310 may perform any suitable operations. In some embodiments, the processor 310 may interpret and/or execute program instructions and/or process data stored in the memory 312, the data storage 314, or the memory 312 and the data storage 314. In some embodiments, the processor 310 may fetch program instructions from the data storage 314 and load the program instructions into the memory 312. After the program instructions are loaded into the memory 312, the processor 310 may execute the program instructions, such as instructions to perform any of the methods disclosed herein, respectively.

The memory 312 and the data storage 314 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 310. For example, the memory 312 and/or the data storage 314 may store computer applications 320, which may be similar to the computer applications described below. In some embodiments, the computer system 300 may or may not include either of the memory 312 and the data storage 314.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication subsystem 316 may include any component, device, system, or combination thereof that is configured to transmit, receive, and/or otherwise exchange information over a network in order to communicate with any suitable entity, such as with other devices at other locations or at the same location or even within the same system. The communication subsystem 316 may provide for communication among the devices described in the present disclosure, communication networks, computing devices, and other systems. For example, the communication subsystem 316 may allow the system 300 to communicate with other systems, such as other computing devices and/or networks. In some embodiments, the communication subsystem 316 may include a modem, a network card (wireless or wired), an optical communication device, an infrared communication device, a wireless communication device (such as an antenna), and/or chipset. Examples of communication subsystem 316 include a Bluetooth device, an 802.6 device (e.g., that can communicate with a Metropolitan Area Network (MAN)), a WiFi device, a WiMax device, cellular communication facilities, and/or the like.

One skilled in the art will recognize that modifications, additions, or omissions may be made to the system 300 without departing from the scope of the present disclosure. For example, the system 300 may include more or fewer components than those explicitly illustrated and described.

FIG. 4 illustrates an example of an illumination system 426, according to at least one embodiment described in the present disclosure. In the example, the illumination system 400 includes a user interface 440, a computer 434, and an illumination source 430 that includes a number n of light engines 432 LE₁, . . . , LEₙ. The light engines 432 LE₁, . . . , LEₙ output LE₁ illumination, . . . , LEₙ illumination, respectively, that yield a combined output 450 to illuminate a target 411.

In the example, the user interface 440 receives a user input 410, which is used to generate an illumination request 412 that includes a color request and an intensity request. The color request has one or more color selections communicated via the user input 410. Each color selection requests a color output for at least a subset of the light engines 432. The intensity request comprises one or more intensity selections communicated via the user input 410. Each intensity selection requests an intensity output for at least a subset of the light engines 432.

The computer 434 determines intensity inputs using the intensity request, where each intensity input provides an illumination instruction to a light engine LEᵢ. The computer 434 also determines color inputs using the color request, where each color input provides a color instruction to a light engine LEᵢ. The computer 434 then generates light engine inputs 414 from the intensity inputs and the color inputs and sends the light engine inputs 414 to the light engines 432 In an example, the illumination system 426 includes light engines LER and LEL that provide stereoscopic coaxial illumination and light engine LEO that provides oblique illumination. In the example, the computer 434 receives an illumination request (x, y, Io, Ic, Ia) comprising a color request (x, y) and an intensity request (Io, Ic, Ia), where (x, y) represents CIE color coordinates, Io represents the percentage of relative light flux ratio from oblique illumination, Ic represents the percentage of relative light flux ratio from the combined coaxial illumination, and Ia represents the percentage of overall flux level. In response to the illumination request, the computer 434 generates light engine input (x, y, I_{R}) for LE_{R}, light engine input (x, y, I_{L}) for LE_{L}, and light engine input (x, y, I_{B})=for LE_{O} according to techniques described throughout this disclosure, where (x, y) represents the CIE color coordinates, I_{B} represents the intensity instructions for LE_{O}, I_{R} represents the intensity instructions for LE_{R}, and I_{L} represents the intensity instructions for LE_{L}. The computer 434 sends the light engine inputs to the illumination source 430. In response to the light engine input 414, the light engines 432 yield a combined output 450 to illuminate the target 411.

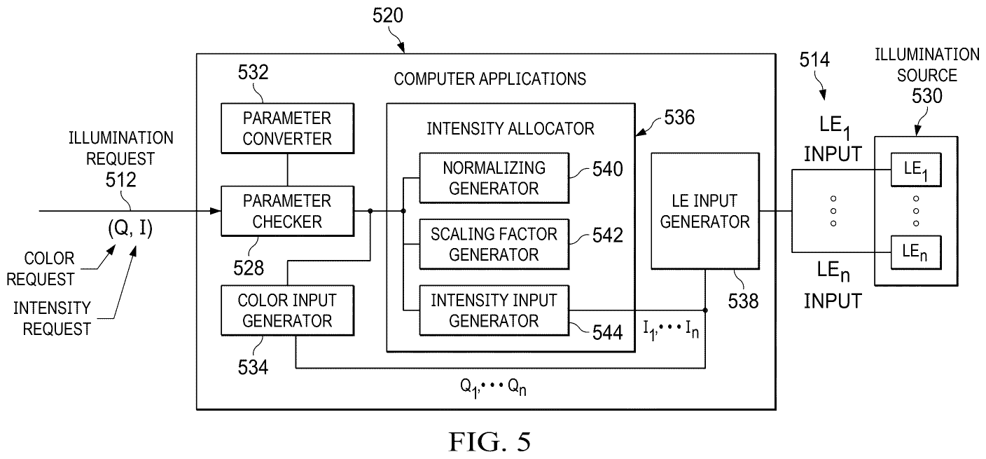

FIG. 5 illustrates an example of computer applications 520 that a computer of an illumination system may use, according to at least one embodiment described in the present disclosure. In the example, the computer applications 520 include a parameter checker 528, a parameter converter 532, a color input generator 534, an intensity allocator 536, and a light engine (LE) input generator 538, which may be communicatively coupled as shown. The intensity allocator 536 includes a normalizing factor generator 540, a scaling factor generator 542, and an intensity input generator 544, which may be communicatively coupled as shown. The computer applications 520 may be used to generate light engine (LE) inputs 514 from an illumination request 512. The light engine inputs LE₁ input, . . . , LEₙ input are sent to light engines LE₁, . . . , LEₙ, respectively, of an illumination system 530.

The computer applications 520 may perform any suitable operations to generate the light engine inputs 514 according to the illumination request 512. In an example, the illumination request 512 (Q, I) may include a color request Q and an illumination request I. In the example, the parameter checker 528 checks whether the illumination request 512 is acceptable. For example, the parameter checker 528 may check whether the values included in the illumination request 512 are within accepted ranges. As another example, the parameter checker 528 may check whether the values are in an accepted format, e.g., whether the color request is in an accepted color format of one or more accepted color formats the computer can use. An accepted color format may be any suitable color format, e.g., as Commission Internationale de l'Éclairage (CIE) color coordinates and/or Correlated Color Temperature (CCT) color coordinates. If the color request is not in an accepted color format, the parameter checker 528 may have the parameter converter 532 convert the color request to an accepted color format.

In the example, the color input generator 534 determines color inputs using the color request, where each color input provides a color instruction to a light engine LEi. The color request may include one or more color selections. If the color request includes only one color selection, the color input generator 534 may generate the same color input for each light engine that yields the selected color, or the color input generator 534 may generate a different color inputs for the light engines such that the combined output yield yields the selected color. If the color request includes more than one color selection, each color selection may request a color output for a distinct subset of the light engines, and the color input generator 534 may generate a separate color input for each color selection.

The intensity allocator 536 determines intensity inputs using the intensity request, where each intensity input provides an illumination instruction to a light engine LEi. In certain embodiments, the intensity input generator 544 determines intensity inputs according to intensity normalizing factors and/or intensity scaling factors. In the embodiments, the normalizing factor generator 540 calculates intensity normalizing factors used to normalize the intensity input values for the light engines according to the maximum intensity values of the light engines. Each intensity normalizing factor may be associated with a particular light engine. An intensity normalizing factor may be determined in any suitable manner, e.g., from a mathematical function of the maximum intensity values of the light engines. Examples of the calculation of the intensity normalizing factors are described in more detail below.

In the embodiments, the scaling factor generator 542 calculates intensity scaling factors used to scale the intensity input values for the light engines according to an intensity distribution, which may be predetermined or provided in the illumination request 512. For example, the illumination request 512 may include an intensity distribution selection requesting a distribution of intensity output values among types of illumination (e.g., oblique and coaxial) or among light engines, and the scaling factor generator 542 calculates intensity scaling factors according to the requested distribution. Each intensity scaling factor may be associated with a particular light engine and may be used to determine the intensity input for that particular light engine.

The intensity scaling factors may be calculated in any suitable manner. In one example, the intensity distribution selection may be a combined intensity selection requesting a combined intensity output for the two or more light engines, e.g., an overall intensity selection requests an overall intensity output for all of the light engines of the illumination system. The scaling factor generator 542 calculates intensity scaling factors that yield the combined intensity output. In another example, the intensity distribution selection may be a relative intensity selection requesting two or more relative intensity values for different types of illumination (e.g., oblique and coaxial). The scaling factor generator 542 calculates intensity scaling factors that yield the relative intensity values. In yet another example, each light engine may be associated with a scaling portion value indicating a portion of intensity output to be provided by the light engine. The scaling factor generator 542 calculates intensity scaling factors that yield the portions indicated by the scaling portion values. Examples of the calculation of intensity scaling factors are described in more detail below.

The intensity input generator 544 determines intensity inputs according to the intensity normalizing factors and/or the intensity scaling factors. An intensity inputs may be determined according to an intensity normalizing factor and/or an intensity scaling factor in any suitable manner, e.g., according to a mathematical function of the intensity normalizing factor and/or the intensity scaling factor. Examples of the calculation of intensity inputs are described in more detail below. The light engine (LE) input generator 538 generates light engine inputs from the intensity inputs and the color inputs and sends the light engine inputs to the light engines 432.

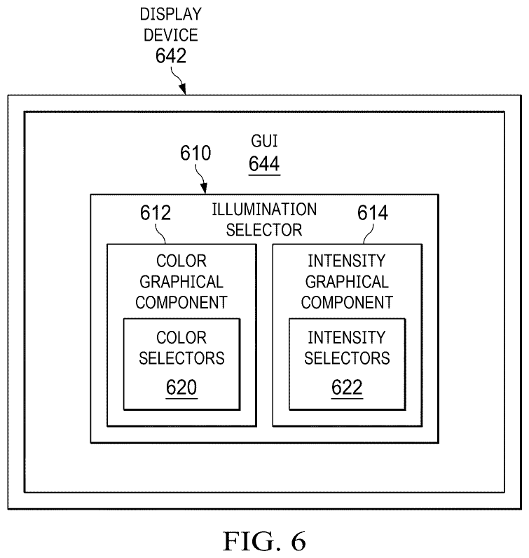

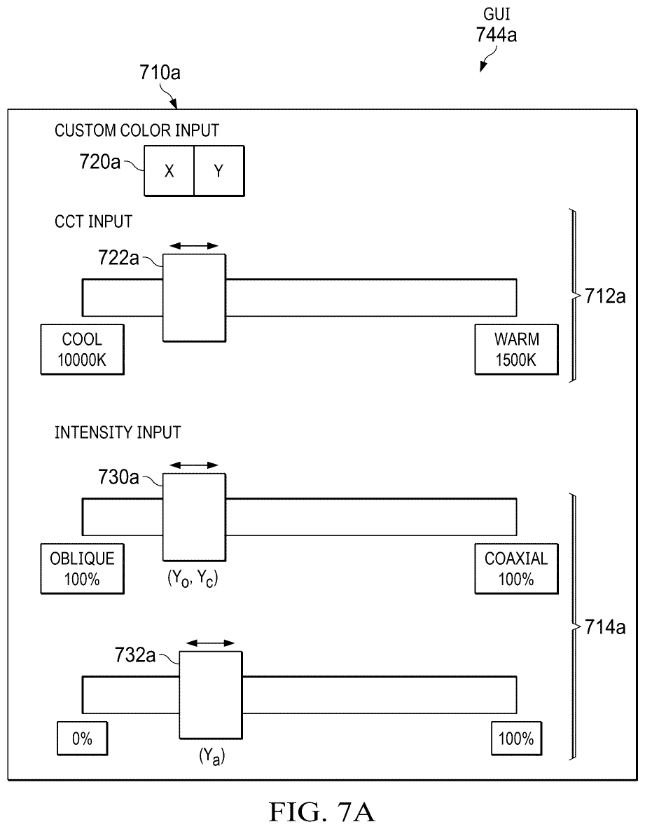

FIG. 6 illustrates an example graphical user interface 644 shown on a display device 642, according to at least one embodiment described in the present disclosure. The graphical user interface 644 includes an illumination selector 610 with a color graphical component 612 and an intensity graphical component 614. The color graphical component 612 has one or more color selectors 620, where each color selector 620 can receive a color selection selected from multiple color options. The intensity graphical component 614 has one or more intensity selectors 622, where each intensity selector 622 can receive an intensity selection selected from multiple intensity options.

A color selector 620 may be presented by the display device 642 in any suitable manner that allows for selection of one or more colors. For example, a color selector 620 may be presented as one or more fields configured to receive input (e.g., alphanumeric characters) representing the color selection. As another example, a color selector 620 may be presented as a color temperature selector configured to receive a color temperature selection. As another example, a color selector 620 may be presented as a multiple color selector configured to receive multiple color selections, where each color selection requests a color output for a distinct subset of light engines.

As another example, the display device 642 may present a color selector 620 as a graphic representing a color coordinate map of coordinates, where each coordinate represents a particular color, e.g., a CIE coordinate map or a CCT coordinate map. In the example, the display device 642 detects the selection of a coordinate of the color coordinate map as the color selection. As another example, the display device 642 may present a color selector 620 as a graphic representing a color curve of points, where each point represents a particular color. In the example, the display device 642 detects selection of a point of the color curve as the color selection.

An intensity selector 622 allows a user to input an intensity selection. The intensity selection may have any suitable format, e.g., a number of intensity units (such as lumens, lux, watts, etc.), a percentage of a maximum intensity, and/or a percentage of a normalized maximum intensity. The intensity selector 622 may be presented by the display device 642 in any suitable manner that allows for selection of intensity. For example, an intensity selector 622 may be presented as one or more fields configured to receive input (e.g., alphanumeric characters) representing the intensity selection. As another example, an intensity selector 622 may be presented as an illumination output intensity selector configured to receive an illumination output intensity selection for illumination provided by one or more light engines (e.g., by the coaxial light engines and/or the oblique light engines) of the illumination system. As another example, an intensity selector 622 may be presented as an intensity distribution selection configured to receive a distribution of illumination among light engines, e.g., the coaxial light engines should output X lumens of the light and the oblique light engine should output Y lumens of the light.

As another example, an intensity selector 622 may be presented as a combined intensity selector configured to receive a combined intensity selection for two or more light engines, e.g., the combined intensity of two coaxial light engines should be X lumens. As another example, an intensity selector 622 may be presented as an overall intensity selector configured to receive an overall intensity selection for the light engines of the illumination system. As another example, an intensity selector 622 may be presented as a relative intensity selector configured to receive two or more relative intensity values for the two or more light engines of the plurality of light engines, e.g., the total coaxial light engines should output X % of the light and the oblique light engine should output 1-X % of the light.

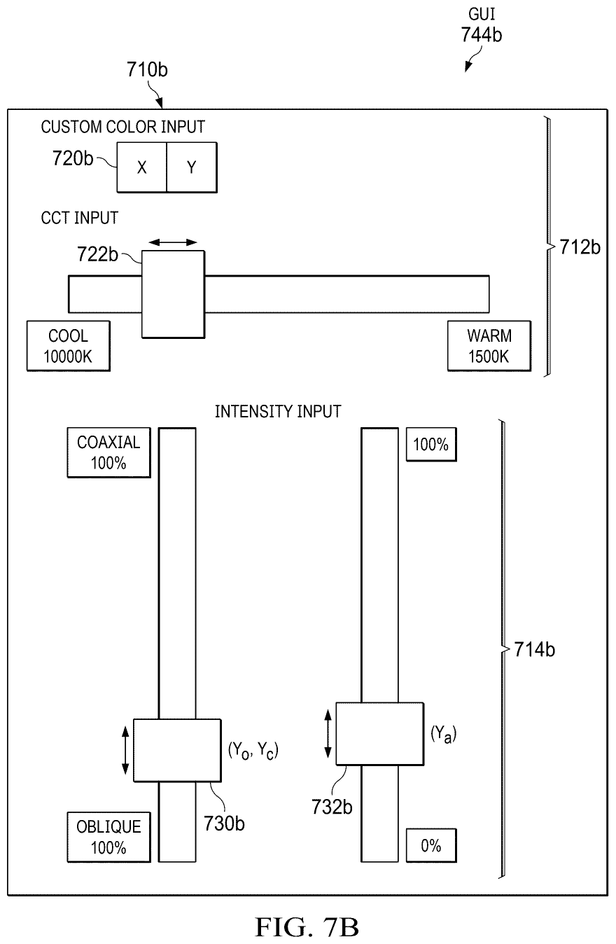

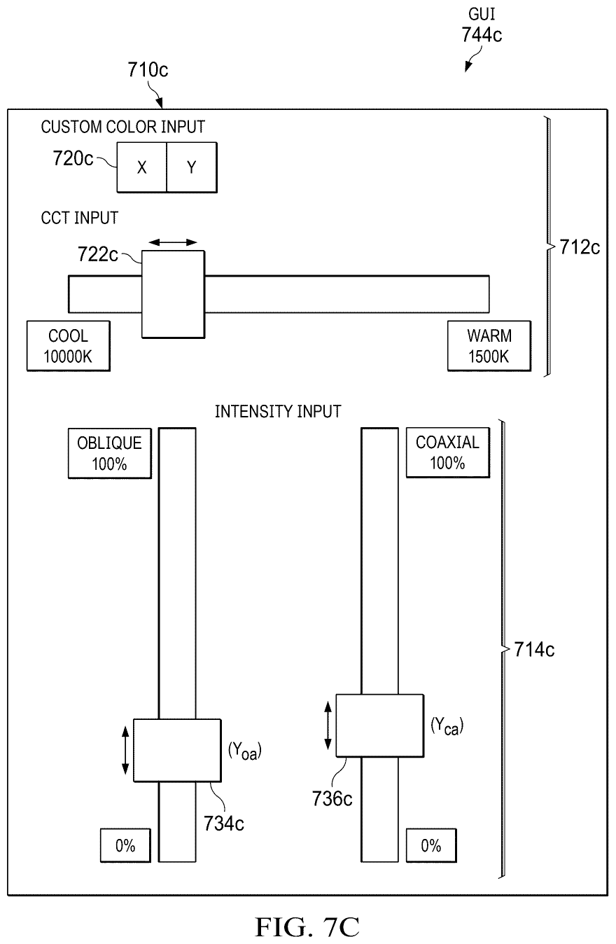

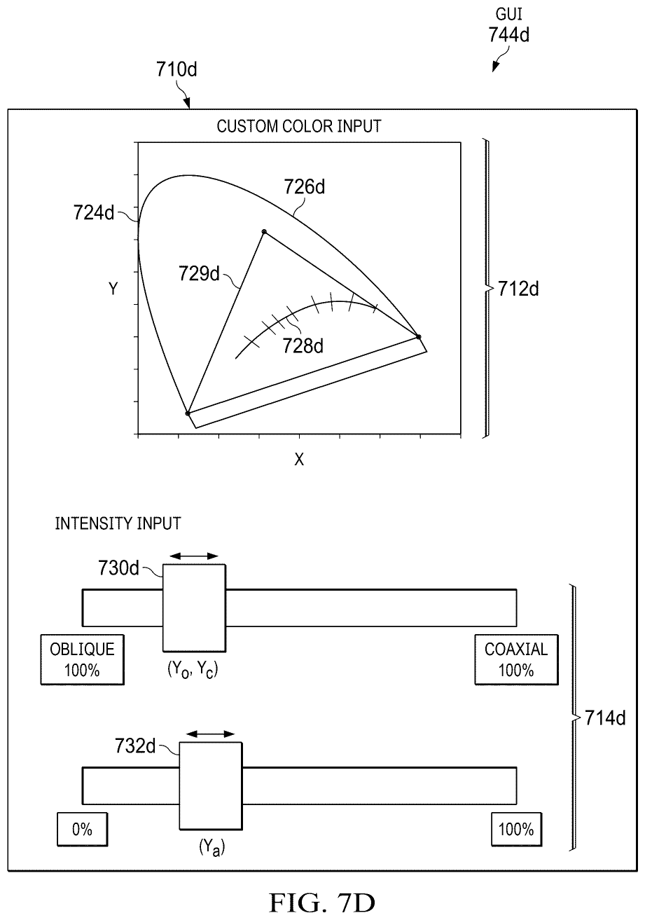

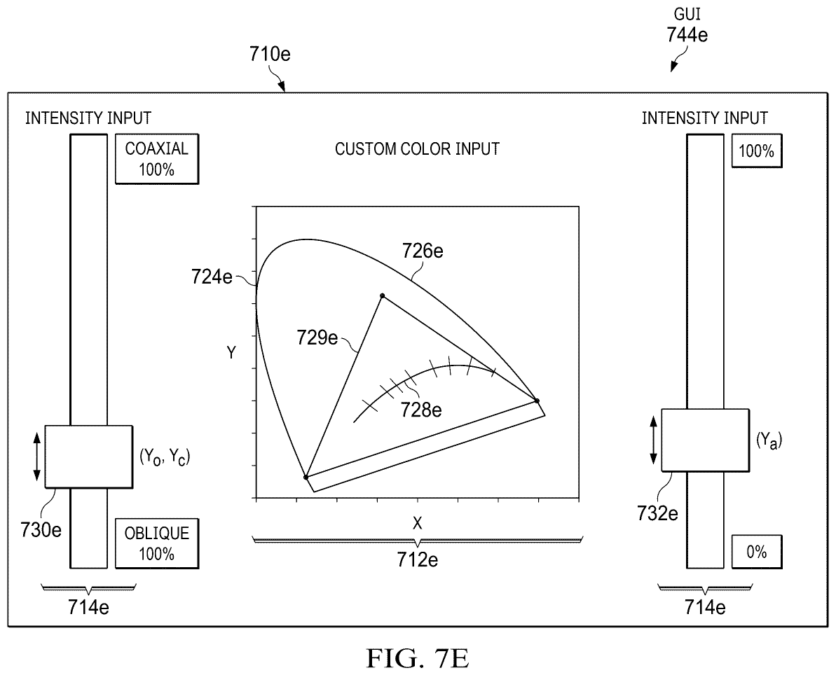

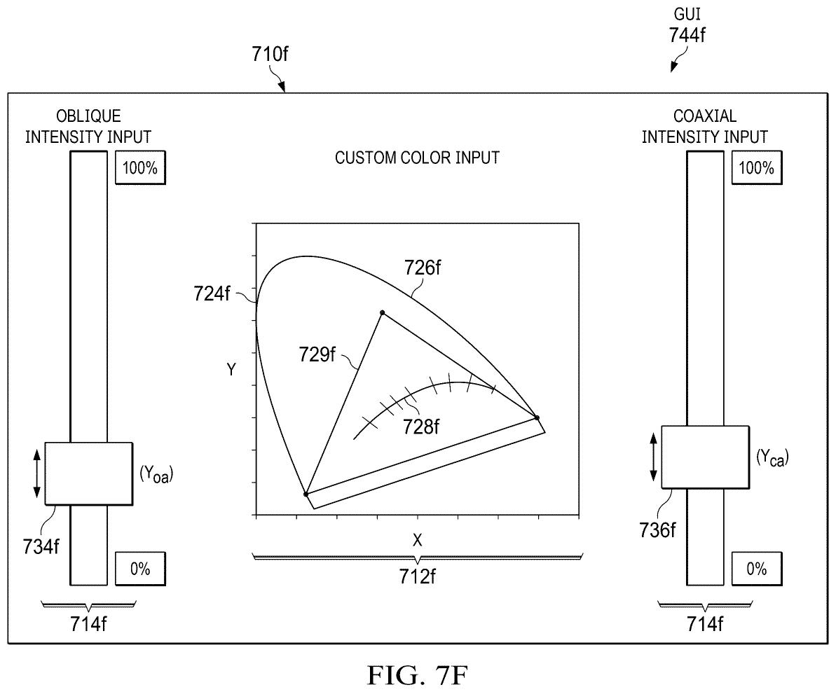

FIGS. 7A through 7F illustrate example graphical user interfaces 744 (744a through 744f) that may be used to select the color and/or intensity of illumination, according to at least one embodiment described in the present disclosure. Generally, a graphical user interface 744 (744a through 744f) includes an illumination selector 710 (710a through 710f, respectively) with a color graphical component 712 (712a through 712f, respectively) and an intensity graphical component 714 (714a through 714f, respectively). The color graphical component 712 has one or more color selectors, and the intensity graphical component 714 has one or more intensity selectors. The color selectors and the intensity selectors may have any suitable size, shape, color, or graphical form, e.g., a menu, a dial, a slider, a character field, a selectable graph, selectable text, an icon, or other graphical form that allows a user to select an option.

FIG. 7A illustrates the GUI 744a with the illumination selector 710a that includes the color graphical component 712a and the intensity graphical component 714a. The color graphical component 712a has color selectors that include one or more color fields 720a and a color temperature selector 722a. The one or more color fields 720a are configured to receive a code (e.g., a CIE color coordinate) representing a color selection. The color temperature selector 722a is configured to receive a color temperature selection (e.g., correlated color temperature (CCT selection)) selected from multiple color temperature options. The color temperature options may range from warm to cool temperatures, such as a range from 1500 to 10000 degrees Kelvin (K).

The intensity graphical component 714a has intensity selectors that include a relative intensity selector 730a and an overall intensity selector 732a. The relative intensity selector 730a is configured to receive relative intensity values for different types of illumination. In the example, the relative intensity selector 730a is a slider that allows the user to select a percentage for oblique illumination and a percentage for coaxial illumination, where the total of the percentages is 100%. The overall intensity selector 732a is configured to receive an overall intensity selection for the plurality of light engines from, e.g., 0% to 100%.

FIG. 7B illustrates the GUI 744b with the illumination selector 710b that includes the color graphical component 712b and the intensity graphical component 714b. The color graphical component 712b has color selectors that include one or more color fields 720b (which may be substantially similar to the color fields 720a of FIG. 7A) and a color temperature selector 722b (which may be substantially similar to the color temperature selector 722a of FIG. 7A). The intensity graphical component 714b has intensity selectors the include a relative intensity selector 730b (which may be substantially similar to the relative intensity selector 730a of FIG. 7A) and an overall intensity selector 732b (which may be substantially similar to the overall intensity selector 732a of FIG. 7A).

FIG. 7C illustrates the GUI 744c with the illumination selector 710c that includes the color graphical component 712c and the intensity graphical component 714c. The color graphical component 712c has color selectors that include one or more color fields 720c (which may be substantially similar to the fields 720a of FIG. 7A) and a color temperature selector 722c (which may be substantially similar to the color temperature selector 722a of FIG. 7A).

The intensity graphical component 714c has intensity selectors that include illumination output intensity selectors 734c and 736c, each configured to receive an illumination output intensity selection for the illumination emitted by one or more light engines of the illumination system. The illumination output intensity selectors 734c and 736c include an oblique illumination output intensity selector 734c and a coaxial illumination output intensity selector 736c. The oblique illumination output intensity selector 734c receives an illumination output intensity selection for oblique illumination, and the coaxial illumination output intensity selector 736c receives an illumination output intensity selection for coaxial illumination.

FIG. 7D illustrates the GUI 744d with the illumination selector 710d that includes the color graphical component 712d and the intensity graphical component 714d. The color graphical component 712d has color selectors that include a graphical element 724d that includes a color coordinate map 726d and/or a color curve 728d. The coordinates of the color coordinate map 726d and/or the color curve 728d represent the options that the user can select with, e.g., a touchscreen or a computer mouse. A computer may detect the selected coordinates to receive the user's selection. In the example, the color coordinate map 726d represents a CIE color coordinate map, where each coordinate represents a color selection. A triangle 729d represents the colors that the light engines of the illumination system can provide. The color curve 728d represents a CCT color curve. The user may select a color point (x, y) within the triangle 729d or on the color curve 728d to select a color. A computer can detect the selected color point (x, y) to receive the user's selection.

The intensity graphical component 714d has intensity selectors the include a relative intensity selector 730d (which may be substantially similar to the relative intensity selector 730a of FIG. 7A) and an overall intensity selector 732d (which may be substantially similar to the overall intensity selector 732a of FIG. 7A).

FIG. 7E illustrates the GUI 744e with the illumination selector 710e that includes the color graphical component 712e and the intensity graphical component 714e. The color graphical component 712e has color selectors that include a graphical element 724e representing a color coordinate map 726e (with a triangle 729e) and/or a color curve 728e (which may be substantially similar to the graphical element 724d, the color coordinate map 726d, the triangle 729d, and/or the color curve 728d, respectively, of FIG. 7D).

The intensity graphical component 714e has intensity selectors that include a relative intensity selector 730e and an overall intensity selector 732e (which may be substantially similar to the relative intensity selector 730a and the overall intensity selector 732a, respectively, of FIG. 7A).

FIG. 7F illustrates the GUI 744f with the illumination selector 710f that includes the color graphical component 712f and the intensity graphical component 714f. The color graphical component 712f has color selectors that include a graphical element 724f representing a color coordinate map 726f (with a triangle 729f) and/or a color curve 728f (which may be substantially similar to the graphical element 724d, the color coordinate map 726d, the triangle 729d, and/or the color curve 728d, respectively, of FIG. 7D).

The intensity graphical component 714f has intensity selectors that include an oblique illumination output intensity selector 734f and a coaxial illumination output intensity selector 736f (which may be substantially similar to the oblique illumination output intensity selector 734c and the coaxial illumination output intensity selector 736c of FIG. 7C).

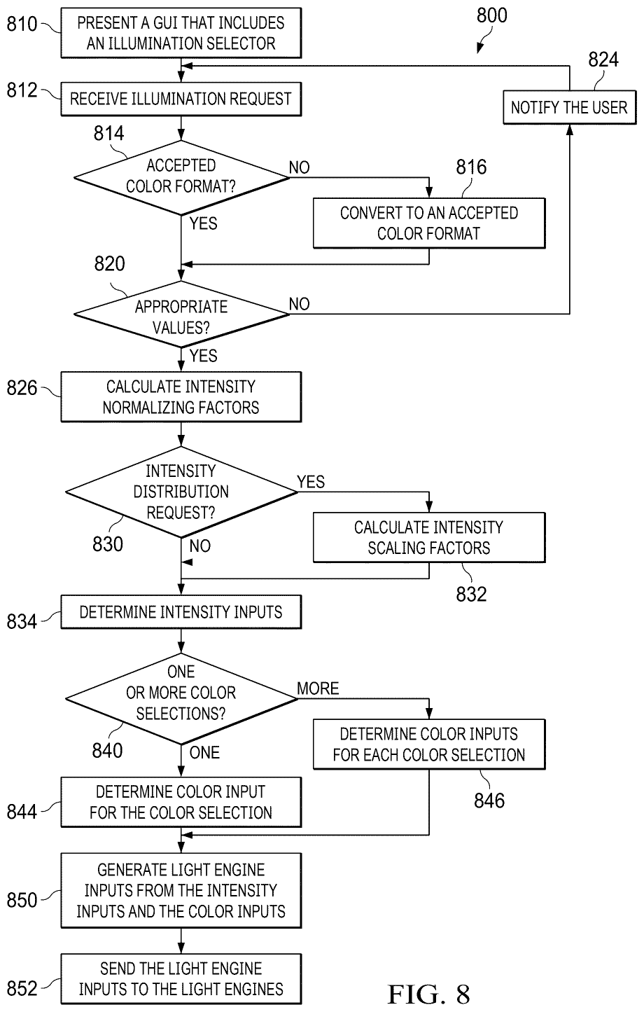

FIGS. 8 through 11 illustrate examples of methods for generating light engine inputs, according to at least one embodiment described in the present disclosure. In certain embodiments, the methods may be performed by an illumination system, such as the illumination system 126 and/or 426.

FIG. 8 illustrates an example of a method 800 for generating light engine inputs, according to at least one embodiment described in the present disclosure.

At block 810, a display device presents a graphical user interface (GUI) that includes an illumination selector. A user may submit an illumination request using the illumination selector.

At block 812, a computer of the illumination system receives the illumination request, which may include a color request and an intensity request.

At block 814, the computer checks whether the color request is in an accepted color format of one or more accepted color formats. For example, an accepted color format may be Commission Internationale de l'Éclairage (CIE) color coordinates and/or Correlated Color Temperature (CCT) color coordinates. If the color request is not in an accepted color format, the method 800 proceeds to block 816. If the color request is in an accepted color format, the method 800 proceeds to block 820.

At block 816, the computer converts the color request to an accepted color format.

At block 820, the computer checks whether the values of the illumination request are appropriate,. For example, the values may be appropriate if they are within predetermined ranges. If the values are not appropriate, the method 800 proceeds to block 824. If the values are appropriate, the method 800 proceeds to block 826.

At block 824, the computer notifies the user, e.g., via a user interface, that the values are not appropriate. The method 800 may return to block 812. At block 812, the method 800 may receive an updated illumination request from the user.

At block 826, the computer calculates intensity normalizing factors used to normalize the intensity input values for the light engines.

At block 830, an intensity distribution request may be performed. For example, an intensity distribution request may request a specific distribution of illumination between, e.g., coaxial illumination and oblique illumination. The illumination request may include the intensity distribution request, or the intensity distribution request may be predetermined. If there is an intensity distribution request, the method 800 proceeds to block 832. If there is no intensity distribution request, the method 800 proceeds to block 834.

At block 832, the computer calculates intensity scaling factors. The intensity scaling factors are used to scale the intensity inputs for the light engines according to the intensity distribution request. For example, intensity scaling factors may scale e.g., coaxial illumination and oblique illumination, according to the requested distribution of coaxial illumination and oblique illumination.

At block 834, the computer determines intensity inputs from the intensity normalizing factors and/or the intensity scaling factors. The computer may use any suitable mathematical function to calculate the intensity inputs from the normalizing factors and/or the scaling factors. For example, the computer may multiply the requested overall intensity by the normalizing factors and/or the scaling factors.

At block 840, the illumination request may include one or more color selections. If the illumination request includes only one color selection, the method 800 proceeds to block 844. If the illumination request includes more than one color selection, the method 800 proceeds to block 846.

At block 844, the computer determines the color input for the one color selection.

At block 846, the computer determines color inputs for each color selection.

At block 850, the computer generates light engine (LE) inputs from the intensity inputs and the color inputs.

At block 852, the computer sends the light engine inputs to the light engines (LEs).

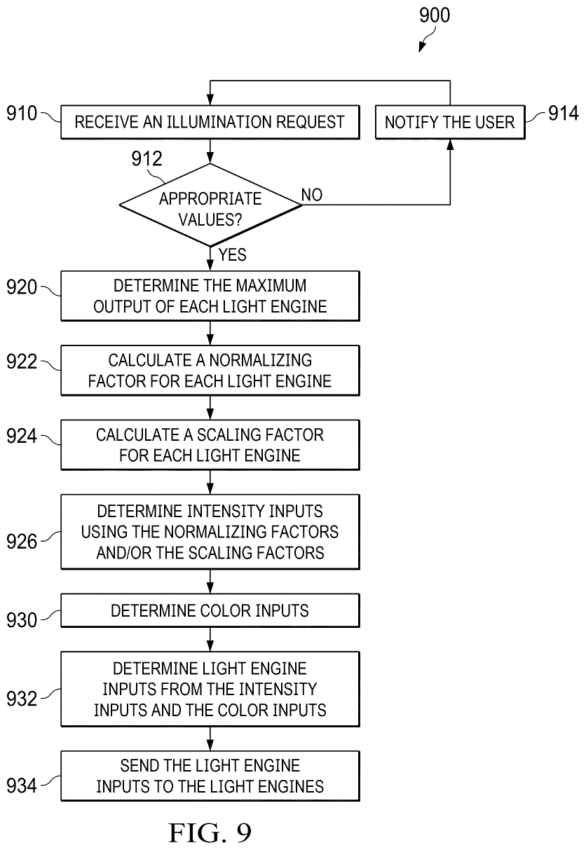

FIG. 9 illustrates another example of a method 900 for generating light engine inputs, according to at least one embodiment described in the present disclosure. In the example, the illumination system includes an oblique light engine LE₁ that provides oblique illumination and coaxial light engines LE₂ and LE₃ that provide coaxial illumination.

At block 910, a computer of the illumination system receives an illumination request. In the example, the illumination request is expressed as (x, y, Io, Ic, Ia), with the color request (x, y) and the illumination request (Io, Ic, Ia). The color request (x, y) represents CIE color coordinates for the requested color of output beam, where x+y≤1. The illumination request includes an illumination distribution request (Io, Ic), where intensity Io represents the requested relative percentage of the light flux of oblique illumination, and intensity Ic represents the requested relative percentage of the light flux of coaxial illumination, such that Io+Ic=1. Intensity Ia represents the requested overall flux level, where intensity Ia is in a range of 0 to 100%.

At block 912, the computer checks whether the values are appropriate. In the example, the computer may check that x+y≤1, Io+Ic=1, and/or Ia is in a range of 0 to 100%. If the values are not appropriate, the method 900 proceeds to block 914. If the values are appropriate, the method 900 proceeds to block 920.

At block 914, the computer notifies the user that the values are not appropriate. The method 900 may return to block 910. At block 910, the method 900 may receive an updated illumination request.

At block 920, the computer determines the maximum output of each light engine. The computer may determine the maximum output from information stored at the computer or at the light engine. In the example, the maximum outputs may be expressed as a maximum output C for the light engine LE₁, a maximum output C₂ for the light engine LE₂, and a maximum output C₂ for the light engine LE₃.

At block 922, the computer calculates a normalizing factor for each light engine. The normalizing factors are used to normalize the output of each light engine. In the example, the normalizing factor of a particular light engine may be calculated by determining the overall minimum value of all of the maximum outputs and taking the ratio of the overall minimum value over the maximum value of the particular light engine. For example, the overall minimum value of all of the maximum outputs may be expressed as a minimum maximum output C=min (C₁, C₂, C₂). The normalizing factors may then be expressed as a normalizing factor K₁=C/C₁ for the light engine LE₁, a normalizing factor K₂=C/C₂ for the light engine LE₂, and a normalizing factor K₃=C/C₃ for the light engine LE₃.

At block 924, the computer calculates a scaling factor for each light engine. The scaling factors are used to scale the output of each light engine with the overall intensity and may be calculated according to relative intensities of an illumination distribution request. In the example, the scaling factor of a light engine may be determined by determining the overall maximum value of the requested intensities of the light engines and taking the ratio of the requested intensity of the light engine over the overall maximum value. For example, the overall maximum value of all of the requested intensities may be expressed as the maximum intensity Im=Max (Io, Ic/2). (Intensity Ic is divided by the number of light engines providing the coaxial illumination to yield the intensity request for each light engine.) The scaling factors may then be expressed as a scaling factor M₁=Io/Im for the light engine LE₁ and as a scaling factor M₂=M₃=(Ic/2)/Im for the light engine LE₂ and LE₃, respectively.

At block 926, the computer determines intensity inputs using the normalizing factors and/or the scaling factors. The computer may use any suitable mathematical function to calculate the intensity inputs according to the normalizing factors and/or the scaling factors. In the example, intensity inputs may be determined by multiplying the requested overall intensity by the normalizing factors and the scaling factors. For example, the intensity inputs may be expressed by an intensity input I₁=Ia*K₁ *M₁ for the light engine LE₁, an intensity input I₂=Ia*K₂ *M₂ for the light engine LE₂, and an intensity input I₃=Ia*K₃ *M₃ for the light engine LE₃.

At block 930, the computer determines color inputs. The color inputs may be any suitable combination of inputs that yield the requested color. In the example, the color request is (x, y), so the color inputs for light engines LE₁, LE₂, and LE₃ may be the color (x, y) or any other combination of color inputs that yield the color (x, y).

At block 932, the computer determines light engine inputs from the intensity inputs and the color inputs. In the example, the light engine inputs may be expressed as a light engine input (x, y, I₁) for the light engine LE₁, a light engine input (x, y, I₂) for the light engine LE₂, and a light engine input (x, y, I₃) for the light engine LE₃.

At block 934, the computer sends the light engine inputs to the light engines. In the example, the computer sends the light engine input (x, y, I₁) to the light engine LE₁, the light engine input (x, y, I₂) to the light engine LE₂, and the light engine input (x, y, I₃) to the light engine LE₃.

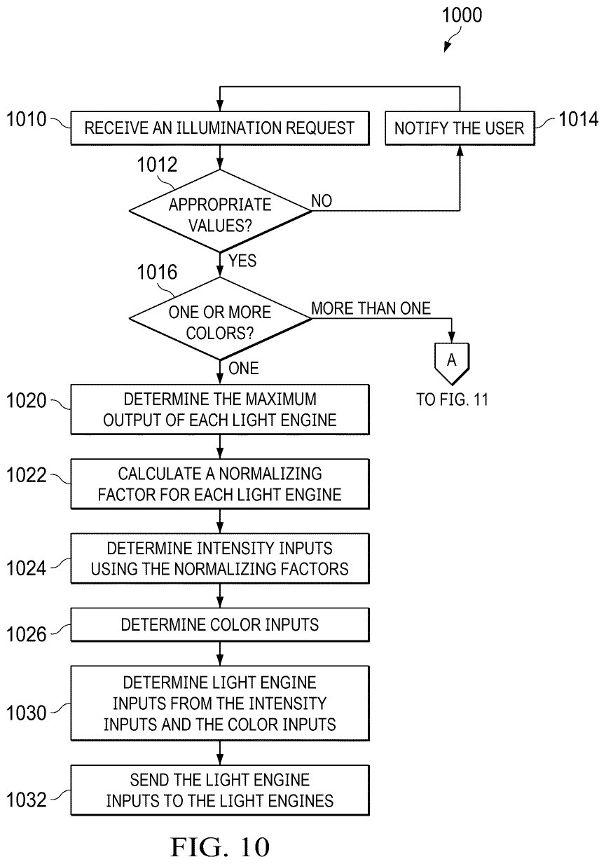

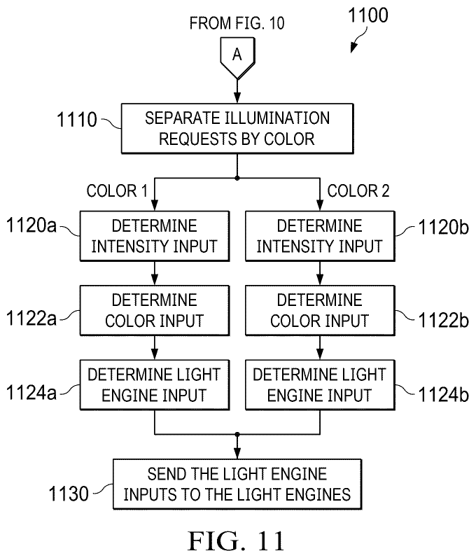

FIG. 10 illustrates another example of a method 1000 for generating light engine inputs, according to at least one embodiment described in the present disclosure. In an example, the illumination system includes an oblique light engine LE₁ that provides oblique illumination and coaxial light engines LE₂ and LE₃ that provide coaxial illumination.

At block 1010, a computer of the illumination system receives an illumination request. In the example, the illumination request is expressed as (xo, yo, Io) for oblique illumination and (xc, yc, Ic) for coaxial illumination. In the oblique illumination request, the color request (xo, yo) represents the CIE color coordinates for the requested color of the oblique illumination, where xo+yo≤1, and the intensity request Io represents the requested relative percentage of the light flux from the oblique light engine LE₁. In the coaxial illumination request, color request (xc, yc) represents the CIE color coordinates for the requested color of the coaxial illumination, where xc+yc≤1, and intensity request Ic represents the requested relative percentage of the light flux from the coaxial light engines LE₂ and LE₃.

At block 1012, the computer checks whether the values are appropriate. In the example, the computer may check that xo+yo≤1, xc+yc≤1. If the values are not appropriate, the method 1000 proceeds to block 1014. If the values are appropriate, the method 1000 proceeds to block 1016.

At block 1014, the computer notifies the user that the values are not appropriate. The method 1000 may return to block 1010. At block 1010, the method 1000 may receive an updated illumination request.

At block 1016, the illumination request may request one or more colors. In the example, if color (xo, yo)=(xc, yc), then one color is requested. If color (xo, yo)≠(xc, yc), then more than one color is requested. If more than one color is requested, then the method 1000 proceeds to a method described with reference to FIG. 11. If one color is requested, then method 1000 proceeds to block 1020.

At block 1020, the computer determines the maximum output of each light engine. In the example, the maximum outputs may be expressed as a maximum output C₁ for the light engine LE₁, a maximum output C₂ for the light engine LE₂, and a maximum output C₂ for the light engine LE₃.

At block 1022, the computer calculates a normalizing factor for each light engine. The normalizing factors are used to normalize the output of each light engine. In the example, the normalizing factor of a particular light engine may be calculated by determining the overall minimum value of all of the maximum outputs and taking the ratio of the overall minimum value over the maximum value of the particular light engine. For example, the minimum value of all of the maximum outputs may be expressed as overall minimum maximum C=min (C₁, C₂, C₂). The normalizing factors may then be expressed as a normalizing factor K₁=C/C₁ for the light engine LE₁, as a normalizing factor K₂=C/C₂ for the light engine LE₂, and as a normalizing factor K₃=C/C₃ for the light engine LE₃.

At block 1024, the computer determines intensity inputs using the normalizing factors. The computer may use any suitable mathematical function to calculate the intensity inputs. In the example, intensity inputs may be determined by multiplying the requested overall intensity by the normalizing factors, e.g., an intensity input I₁=Ia*K₁ for the light engine LE₁, an intensity input I₂=Ia*K₂ for the light engine LE₂, and an intensity input I₃=Ia*K₃ for the light engine LE₃.

At block 1026, the computer determines color inputs. In the example, the requested color for oblique illumination is the same as the requested color for coaxial illumination, i.e., color (xo, yo)=(xc, yc), which may then be expressed as color (x, y)=(xo, yo)=(xc, yc). The color input for light engines LE₁, LE₂, and LE₃ is (x, y).

At block 1030, the computer determines light engine inputs according to the color inputs and the intensity inputs. In the example, the light engine inputs may be expressed as a light engine input (x, y, I₁) for the light engine LE₁, a light engine input (x, y, I₂) for the light engine LE₂, and a light engine input (x, y, I₃) for the light engine LE₃.

At block 1032, the computer sends the light engine inputs to the light engines. In the example, the computer sends the light engine input (x, y, I₁) to the light engine LE₁, the light engine input (x, y, I₂) to the light engine LE₂, and the light engine input (x, y, I₃) to the light engine LE₃.

FIG. 11 illustrates another example of a method 1100 for generating light engine inputs, according to at least one embodiment described in the present disclosure. The illumination request requests more than one color, such as two, three, four, or more colors up to the number of light engines present in the illumination system.

At step 1110, the computer separates the illumination requests by color to calculate the light engine inputs by color for each of the colors. In the example, the illumination request is expressed as (xo, yo, Io) for oblique illumination and (xc, yc, Ic) for oblique illumination, where (xo, yo)≠(xc, yc). The illumination requests are separated into Color 1 representing color (xo, yo) for the oblique illumination and Color 2 representing color (xc, yc) for the coaxial illumination.

At block 1120a, the computer determines the intensity input for the oblique illumination. In the example, the intensity request for the oblique illumination is intensity Io, so the intensity input is also intensity Io.

At block 1122a, the computer determines the color input for the oblique illumination. In the example, the color request for the oblique illumination is color (xo, yo), so the color input is also color (xo, yo).

At block 1124a, the computer determines the light engine input. In the example, the intensity input is intensity Io, and the color request is color (xo, yo), so the light engine input for the oblique illumination is (xo, yo, Io).

At block 1120b, the computer determines the intensity input for the coaxial illumination. The computer may determine the intensity input using normalizing factors in a manner similar to that of FIG. 10. For example, the computer determines the maximum output of each light engine, e.g., the maximum output C₂ for the light engine LE₂ and the maximum output C₂ for the light engine LE₃, and then determines the overall minimum value of the maximum outputs as an overall minimum maximum value C=min (C₂, C₂). The normalizing factors may then be calculated as normalizing factor K₂=C/C₂ for the light engine LE₂ and normalizing factor K₃=C/C₃ for the light engine LE₃. The intensity inputs may be calculated as intensity input I₂=Ic*K₂ for the light engine LE₂ and intensity input I₃=Ic*K₃ for the light engine LE₃.

At block 1122b, the computer determines the color input for the coaxial illumination. In the example, the color request for the coaxial illumination is color (xc, yc), so the color input is also color (xc, yc).

At block 1124b, the computer determines the light engine inputs according to the color inputs and the intensity inputs. In the example, the light engine inputs may be expressed as a light engine input (xc, yc, I₂) for the light engine LE₂ and a light engine input (xc, yc, I₃) for the light engine LE₃.

At block 1130, the computer sends the light engine inputs to the light engines. In the example, the computer sends the light engine input (xo, yo, Io) to the light engine LE₁, the light engine input (xc, yc, I₂) to the light engine LE₂, and the light engine input (xc, yc, I₃) to the light engine LE₃.

The present disclosure (including the specification, claims, and drawings) includes example embodiments that are intended to aid the reader in understanding the invention and concepts contributed by the inventor to furthering the art and to enable any person skilled in the art to make or use the disclosed embodiments. Modifications (e.g., changes, substitutions, additions, omissions, and/or other modifications) to the embodiments will be readily apparent to those skilled in the art. Accordingly, modifications may be made to the embodiments without departing from the essence of the present disclosure.

In certain instances, modifications may be made to the systems disclosed herein, as apparent to those skilled in the art. For example, parts of a system may be integrated or separated, or an operation of a system may be performed by more, fewer, or other parts. In certain instances, modifications may be made to the methods disclosed herein, as apparent to those skilled in the art. For example, the methods may include more, fewer, or other operations. As another example, certain operations may be optional, combined into fewer operations, or expanded into additional operations. As yet another example, certain operations may be performed in any suitable order or simultaneously.

Furthermore, those skilled in the art will recognize that the present disclosure is not intended to be limited to the example embodiments and that the language of the disclosure is to be accorded the widest scope consistent with the present disclosure. Terms (which may include one or more words) that describe inclusion are generally intended as “open” terms in that they generally do not imply exclusion. For example, the term “including” may be interpreted as “including, but not limited to” or “including at least”; the term “having” may be interpreted as “having, but not limited to” or “having at least”; and the term “comprising” may be interpreted as “comprising, but not limited to” or “comprising at least”, etc.

Additionally, if a specific number is intended, such intent will be explicitly recited in the claim. In the absence of the explicit recitation of a specific number, no such intent is present. If a specific number is explicitly recited, such recitation should be interpreted to mean at least the recited number. For example, the bare recitation of “two Xs”, without other modifiers, may mean “at least two Xs” or “two or more Xs”. Moreover, the use of an indefinite article (e.g., “a” or “an”) or definite article (e.g., “the”) to introduce a noun phrase should not be construed to limit the noun phrase to one, but may be interpreted as an open term “at least one” or “one or more”. This holds even when the same claim includes an open term (e.g., “one or more” or “at least one”) and an indefinite or definite article (e.g., “a” or “an” or “the”).

Moreover, a selection from a list of items should be understood to contemplate a selection of any suitable individual item or any suitable combination of items. For example, the general construction “at least one of A, B, and C” or “one or more of A, B, and C” may include A alone; B alone; C alone; A and B together; A and C together; B and C together; and A, B, and C together. Moreover, any disjunctive term presenting two or more alternative items may be understood to contemplate including one of the items, either of the items, or both items. For example, the general construction “A or B” or “A and/or B” may include A alone, B alone, and A and B together. Additionally, the use of the terms “first,” “second,” “third,” etc. are not necessarily used herein to connote a specific order. For example, the terms “first,” “second,” “third,” etc., may be used to distinguish between different elements.

To aid the Patent Office and readers in interpreting the claims, Applicants note that they do not intend any of the claims or claim elements to invoke 35 U.S.C. § 112(f), unless the words “means for” or “step for” are explicitly used in the particular claim. Use of any other term (e.g., “mechanism,” “module,” “device,” “unit,” “component,” “element,” “member,” “apparatus,” “machine,” “system,” “processor,” or “controller”) within a claim is understood by the Applicants to refer to structures known to those skilled in the art and is not intended to invoke 35 U.S.C. § 112(f).

What is claimed:

1. An illumination system for a microscope, comprising:
an illumination source comprising a plurality of light engines, each light engine of the plurality of light engines configured to emit an illumination output having a color and an intensity, each light engine of the plurality of light engines associated with a maximum intensity value yielding a plurality of maximum intensity values of the plurality of light engines; and
a computer configured to:
receive an illumination request comprising a color request and an intensity request, the color request comprising one or more color selections, each color selection of the one or more color selections requesting a color output for at least a subset of the plurality of light engines, the intensity request comprising one or more intensity selections, each intensity selection of the one or more intensity selections requesting an intensity output for at least a subset of the plurality of light engines;
determine a plurality of intensity inputs according to the intensity request, each intensity input of the plurality of intensity inputs providing an illumination instruction to a light engine of the plurality of light engines;
determine a plurality of color inputs according to the color request, each color input of the plurality of color inputs providing a color instruction to a light engine of the plurality of light engines;
generate a plurality of light engine inputs from the plurality of intensity inputs and the plurality of color inputs; and
send the plurality of light engine inputs to the plurality of light engines.

2. The illumination system of claim 1, the computer further configured to:
calculate a plurality of intensity normalizing factors according to the plurality of maximum intensity values of the plurality of light engines, each intensity normalizing factor of the plurality of intensity normalizing factors associated with a light engine of the plurality of light engines; and
determine the plurality of intensity inputs according to the plurality of intensity normalizing factors.

3. The illumination system of claim 1:
an intensity selection of the one or more intensity selections comprising an intensity distribution selection requesting a distribution of one or more intensity output values for two or more light engines of the plurality of light engines; and
the computer further configured to:
calculate two or more intensity scaling factors according to the distribution of the one or more intensity output values, each intensity scaling factor of the two or more intensity scaling factors associated with a light engine of the two or more light engines of the plurality of light engines; and
determine two or more intensity inputs of the plurality of intensity inputs according to the two or more intensity scaling factors, each intensity input of the two or more intensity inputs associated with the two or more light engines of the plurality of light engines.

4. The illumination system of claim 3:
each light engine of the two or more light engines associated with a scaling portion value of two or more scaling portion values, each scaling portion value of the two or more scaling portion values indicating a portion of intensity output to be provided by the each light engine; and
the computer further configured to:
calculate the two or more intensity scaling factors according to the two or more scaling portion values.

5. The illumination system of claim 3, the intensity distribution selection comprising a combined intensity selection requesting a combined intensity output for the two or more light engines of the plurality of light engines.

6. The illumination system of claim 3, the intensity distribution selection comprising an overall intensity selection requesting an overall intensity output for the plurality of light engines.

7. The illumination system of claim 3:
the intensity distribution selection comprising a relative intensity selection requesting two or more relative intensity values for the two or more light engines of the plurality of light engines; and
the computer further configured to:
calculate the two or more intensity scaling factors according to the two or more relative intensity values.

8. The illumination system of claim 1:
the one or more color selections comprising a plurality of color selections, each color selection requesting a color output for a distinct subset of the plurality of light engines; and
the computer further configured to:
determine the plurality of color inputs according to the plurality of color selections.

9. The illumination system of claim 1, the computer further configured to:
check whether the color request is in an accepted color format of one or more accepted color formats; and
if the color request is not in an accepted color format of the one or more accepted color formats, convert the color request to an accepted color format of the one or more accepted color formats.

10. The illumination system of claim 1, further comprising a beam director configured to:
receive the illumination output from each light engine of the plurality of light engines; and
direct the illumination output from the each light engine along an optical pathway corresponding to the each light engine.

11. The illumination system of claim 10, the beam director configured to direct the illumination output from the each light engine along the optical pathway corresponding to the each light engine by:
directing one or more coaxial illumination outputs to one or more coaxial optical pathways that are parallel to an optical axis of the microscope.

12. The illumination system of claim 10, the beam director configured to direct the illumination output from the each light engine along the optical pathway corresponding to the each light engine by:
directing one or more oblique illumination outputs along one or more oblique optical pathways that are oblique to an optical axis of the microscope.

13. The illumination system of claim 1:
further comprising a display device configured to present a graphical user interface comprising one or more intensity selectors, each intensity selector of the one or more intensity selectors configured to receive an intensity selection yielding one or more intensity selections; and
the computer further configured to receive the intensity request comprising the one or more intensity selections from the one or more intensity selectors.

14. The illumination system of claim 1:
further comprising a display device configured to present a graphical user interface comprising one or more color selectors, each color selector of the one or more color selectors configured to receive a color selection yielding one or more color selections; and
the computer further configured to receive the color request comprising the one or more color selections from the one or more color selectors.

15. An illumination system for a microscope, comprising:
an illumination source comprising a plurality of light engines, each light engine configured to emit an illumination output having a color and an intensity;
a display device configured to present a graphical user interface configured to generate an illumination request, the graphical user interface comprising a color graphical component and an intensity graphical component, the color graphical component comprising one or more color selectors, each color selector of the one or more color selectors configured to receive a color selection from a plurality of color options to yield one or more color selections, the intensity graphical component comprising one or more intensity selectors, each intensity selector of the one or more intensity selectors configured to receive an intensity selection from a plurality of intensity options to yield one or more intensity selections, the illumination request comprising the one or more color selections and the one or more intensity selections; and
a computer configured to:
receive the illumination request from the display device;
generate a plurality of light engine inputs from the one or more color selections and the one or more intensity selections; and
send the plurality of light engine inputs to the plurality of light engines.

16. The illumination system of claim 15, the display device further configured to present a color selector of the one or more color selectors as one or more fields configured to receive input representing the color selection.

17. The illumination system of claim 15, the display device further configured to:
present a color selector of the one or more color selectors as a graphic representing a color coordinate map; and
detect selection of a coordinate of the color coordinate map as the color selection.

18. The illumination system of claim 15, the display device further configured to:
present a color selector of the one or more color selectors as a graphic representing a color curve; and
detect selection of a point of the color curve as the color selection.

19. The illumination system of claim 15, the display device further configured to:
present a color selector of the one or more color selectors as a color temperature selector configured to receive a color temperature selection from a plurality of color temperature options.

20. The illumination system of claim 15, the display device further configured to:
present a color selector of the one or more color selectors as a multiple color selector configured to receive a plurality of color selections, each color selection requesting a color output for the illumination output emitted by a distinct subset of the plurality of light engines.

21. The illumination system of claim 15, the display device further configured to:
present an intensity selector of the one or more intensity selectors as an illumination output intensity selector configured to receive an illumination output intensity selection for the illumination output emitted by one or more light engines of the plurality of light engines.

22. The illumination system of claim 15, the display device further configured to:
present an intensity selector of the one or more intensity selectors as an intensity distribution selector configured to receive a distribution of one or more intensity output values for the illumination output emitted by two or more light engines of the plurality of light engines.

23. The illumination system of claim 15, the display device further configured to:
present an intensity selector of the one or more intensity selectors as a combined intensity selector configured to receive a combined intensity selection for the illumination output emitted by two or more light engines of the plurality of light engines.

24. The illumination system of claim 15, the display device further configured to:
present an intensity selector of the one or more intensity selectors as an overall intensity selector configured to receive an overall intensity selection for the illumination output emitted by the plurality of light engines.

25. The illumination system of claim 15, the display device further configured to:
present an intensity selector of the one or more intensity selectors as a relative intensity selection configured to receive two or more relative intensity values for the illumination output emitted by two or more light engines of the plurality of light engines.
